(19) United States
(12) Patent Application Publication
(10) Pub. No.: US 2003/0095409 A1
(43) Pub. Date: May 22, 2003

(54) Simplified lighting apparatus

(76) Inventor: Hung-Cheih Cheng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/988,429

(22) Filed: Nov. 20, 2001

(51) Int. Cl. F21V 33/00

(52) U.S. Cl. 362/253; 362/806

(57) ABSTRACT

The present invention relates to a simplified lighting apparatus, which includes a support and a lighting ball. A characteristic connector is provided in the support to connect with several LED bulbs being electrically connected to emit light to the ball that produces special decorative lighting effect of reflection and diffusion.

### BACKGROUND OF THE INVENTION

A conventional lighting apparatus, as shown in FIG. 1, includes a support (1) and a lighting ball (2). The support (1) is provided with a bulb (3) inside to emit light to the ball (2), which becomes a decorative lighting effect. When the bulb (2) is used, it produces heat that makes high temperature in the support (1). In order to prevent from damage, it is necessary to provide radiator inside, such as a fan (4), and to drill some apertures (11) on the wall of the support (1). This known structure is somehow complex and will increases the cost. And the aperture (11) will affect the outlook and strength of the support (1).

Accordingly, the primary object of the invention is to provide a simplified lighting apparatus, which includes a simple inner connector to connect with several LED bulbs to emit light. It does not need a radiator since the high heat is prevented. Now the features and advantages of the present invention will be described in detail with reference to the accompanying drawings.

### BRIEF DESCRIPTION OF ACCOMPANYING DRAWINGS

FIG. 1 is a cross-sectional plan view showing a prior art lighting apparatus having a complex structure.

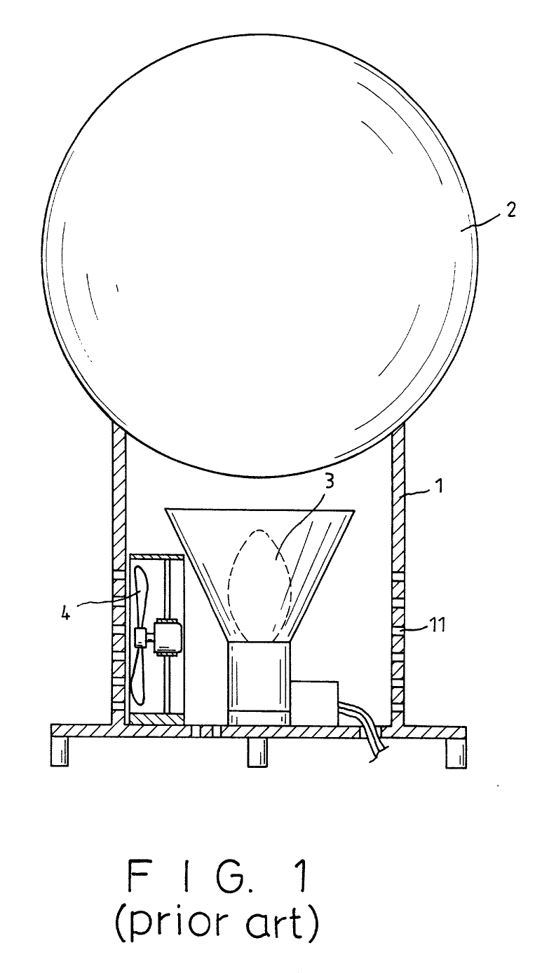

FIG. 2 is a perspective view showing a simplified lighting apparatus according to the present invention.

FIG. 3 is a cross-sectional view showing a simplified lighting apparatus according to the present invention.

### DETAILED DESCRIPTION OF PREFERRED EMBODIMENTS

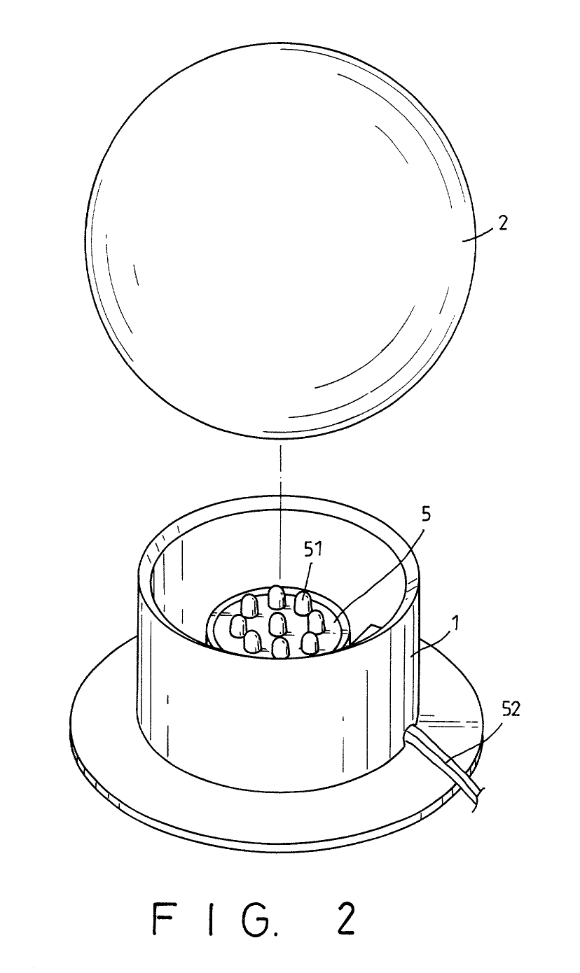

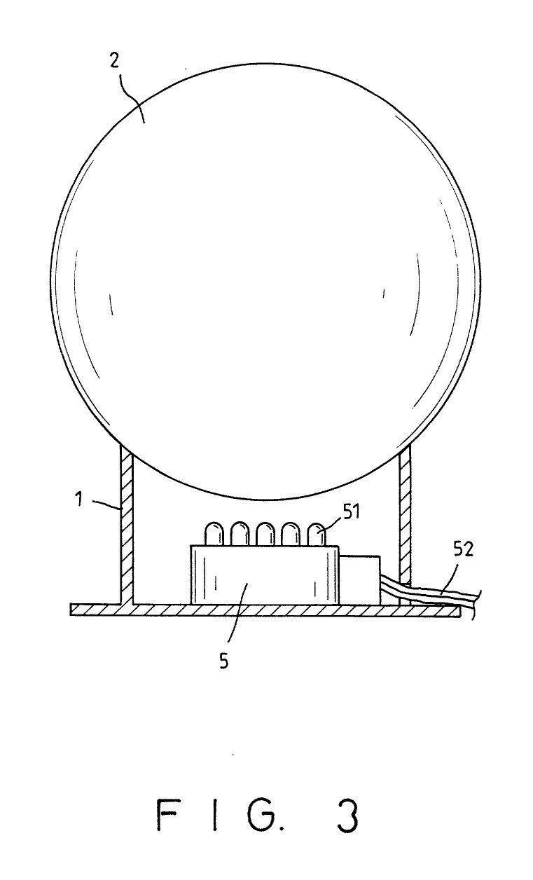

Please refer to FIGS. 2 and 3, the present invention relates to an improvement of a lighting apparatus including a support (1) and a lighting ball (2). A connector (5) provided in the support (1) connects with several LED bulbs (51) thereon. Each LED bulb (51) is electrically connected with an electrical wire (52) being extended outside the support (1). As the electrical wire (52) is connected with a power source, the LED bulb (51) can be lightened to emit light to the ball (2) for lighting reflection or diffusion for a predicted decorative purpose.

Since the LED bulb (51) will not produces high heat during use, any radiator will not be necessary and all means in the support is prevented from damage because of overheat. It is to be understood that the present invention is simplified and the cost will be reduced.

Accordingly, the present invention provides an invented structure with improvement. It obviously gains the utility and novelty for patent and is thus applied.

What is claimed is:

1. A simplified lighting apparatus including a support and a lighting ball, wherein a connector is provided in the support to connect with several LED bulbs being electrically connected to emit light to the ball for decorative lighting effect.
